(19) United States
(12) Patent Application Publication
(10) Pub. No.: US 2015/0010740 A1
(43) Pub. Date: Jan. 8, 2015

(54) Multilayer Films and Methods of Manufacture

(71) Applicant: Avery Dennison Corporation, Glendale, CA (US)

(72) Inventors: Chieh-Wen CHEN, Willoughby Hills, OH (US); Anle XUE, Mentor, OH (US); Hoang T. PHAM, Painesville, OH (US); Yatin PATIL, Mayfield Heights, OH (US)

(21) Appl. No.: 14/322,678

(22) Filed: Jul. 2, 2014

Related U.S. Application Data
(60) Provisional application No. 61/842,303, filed on Jul. 2, 2013.

(51) Int. Cl. B32B 27/08; B32B 27/36; B32B 27/32

(52) U.S. Cl. CPC B32B 27/08; B32B 27/32; B32B 27/36; B32B 2250/40; B32B 2307/736; B32B 2323/043; B32B 2323/046; B32B 2331/04
USPC 428/213; 428/218

(57) ABSTRACT

Films having shrinkage percentage values based, at least in part, upon the core layer densities of the films are disclosed. Methods for manufacturing such films are also disclosed. In addition, methods for selecting a core layer density of a film to obtain a desired film shrinkage percentage are disclosed.

### BACKGROUND OF THE INVENTION

Shrink films have numerous uses, including as product labels and packaging. The present invention provides multilayer shrink films in which the shrink percentage is controlled by the density of a core layer of the film. The present invention further provides methods for manufacturing films and for preparing films to have a predetermined shrink percentage.

### SUMMARY OF THE INVENTION

In one embodiment, the invention includes a method for manufacturing a multilayer film having a desired machine direction shrinkage. The method may include providing reference data including shrink percentages for at least three multilayer films having a core layer comprised of polymeric material and a density in the range of about 0.857 to about 0.94 and a skin layer comprised of shrinkable polymeric material overlying the core layer. The films have substantially the same materials but have distinct core layer densities. In addition, the method may include extrapolating the shrink percentages of the at least three multilayer films having distinct core densities to provide estimate machine direction shrinkage values for multilayer films having core layer densities that are not within the reference data. The method further includes selecting a selected core layer density that will provide a film having the desired machine direction shrinkage.

In another embodiment, the present invention includes a computer readable medium containing program instructions wherein execution of the program instructions by one or more processors of a computer system causes the one or more processors to carry steps. The steps include (i) extrapolating reference data stored in an electronic storage medium, wherein the reference data includes shrink percentages for at least three multilayer films having a core layer, wherein the films have substantially the same materials but have distinct core layer densities, (ii) extrapolating the shrink percentages of the at least three multilayer films having distinct core layer densities to provide estimate machine direction shrinkage values for multilayer films having core layer densities that are not within the reference data, and (iii) providing a core layer density that will provide a film having a desired machine direction shrinkage.

In still another embodiment, the present invention includes a multilayer shrink film. The multilayer shrink film includes a core layer comprised of polymeric material and a skin layer comprised of shrinkable polymeric material, wherein the skin layer overlies the core layer. In addition, the core layer has a density in the range of about 0.857 to about 0.94 and the overall density of the film is less than about 1.0 g/cc. The film is configured to shrink in the machine direction upon exposure to a shrink temperature.

The following description illustrates one or more embodiments of the invention and serves to explain the principles and exemplary embodiment of the invention.

### DETAILED DESCRIPTION OF EXEMPLARY EMBODIMENTS

Reference will now be made in detail to exemplary embodiments of the present invention, one or more examples of which are illustrated in the accompanying drawings. Each example is provided by way of explanation of the invention and not by limitation of the invention. It will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As used herein, the term “overlies” and cognate terms such as “overlying” and the like, when referring to the relationship of one or a first layer relative to another or a second layer, refers to the fact that the first layer partially or completely lies over the second layer. The first layer overlying the second layer may or may not be in contact with the second layer. For example, one or more additional layers may be positioned between the first layer and the second layer.

In some embodiments, the present invention includes multilayer shrink films. As is understood in the art, shrink films are films that shrink in at least one direction when heated to a shrink temperature. In some embodiments, shrink films of the present invention may shrink only in the machine direction upon exposure to a shrink temperature. In other embodiments, shrink films of the present invention may shrink only in the machine direction upon exposure to a shrink temperature and may grow (or expand) in the cross direction. In some embodiments, as described herein, the degree of such directional shrinkage and/or growth of a film may be controlled as a function of the density of a core layer of the film.

In some embodiments, multilayer films of the present invention may include a core layer, one or more optional tie layers, and one or more skin layers. By way of example, in one illustrative embodiment, a film may have layers configured as A/B/C/B/A, wherein A represents a skin layer, B represents a tie layer, and C represents the core layer. In other embodiments using the same designation, films of the present invention may have a configuration of A/C/A. In still other embodiments, multilayer films may have configurations such as, for example, A/C/B, A/B/C/B/D, A/D/B/C/B/D/A, A/C/B/D/B/C/A, wherein A is a skin layer, B is a tie layer, D is a functional skin layer, and C is a core layer. Thus, as indicated, films of the present invention may have a symmetrical or an asymmetrical configuration. In addition, other layers may be present in some films of the present invention, such as one or more barrier layers, adhesive layers, and/or print layers. In some embodiments, at least one outer layer includes a pressure sensitive adhesive.

In some embodiments, each type of layer in a film may have substantially the same composition, such as all skin layers in a film having the same composition. In alternative embodiments, some or all of the skin layers in a film may have differing compositions. In similar fashion, tie layers in a film of the present invention may have substantially the same composition or some or all tie layers may have distinct compositions.

In some embodiments, the core layer may be comprised of polymeric material, such as a polyolefin resin or blends thereof. For example, the core layer in some embodiments of the present invention may be comprised of low density polyethylene, linear low density polyethylene, medium density polyethylene, ethyl vinyl acetate, polypropylene, and blends thereof. In some embodiments, the core layer may additionally or alternatively be comprised of elastomers and/or plastomers, such as those available from The Dow Chemical Company under the product names Engage and Versify, respectively. By way of example, Versify 2300, Versify 3300, Engage 8842, 8100, and/or 8200 may be used in some embodiments. In some embodiments, the core layer may comprise a blend of linear low density polyethylene with one or more plastomers and/or elastomers. In some embodiments, the core layer may also be prepared with other non-olefinic material, such as styrene ethylene butylene styrene (SEBS), poly(styrene-butadiene-styrene) (SBS), poly(styrene-isoprene-styrene) (SIS), and other similar components. In some embodiments, the core layer may have a density between about 0.858 to about 0.94 g/cc. In other embodiments, the core layer may have a density between about 0.86 to about 0.92. In addition, in some embodiments, the thickness of the core layer can range from about 5% to about 95% of the total relative thickness of a particular film. In still other embodiments, the core may be from about 7.5% to about 93% of the total relative thickness of a film. In yet other embodiments, the core may be from about 10% to about 90% of the total relative thickness of a particular film.

In addition, films of the present invention may include one or more skin layers. In some embodiments, at least one skin layer may include a shrinkable polymer. Skin layers may include any shrinkable polymer that is suitable for a given embodiment. By way of example, shrinkable polymers that may be present in a skin layer of the present invention may include, without limitation, cyclic polyolefin (COC), polyolefin, polyester, modified polyester, polyethylene terephthalate glycol-modified (PETG), PETG with polyethylene terephthalate (PET) and optionally antiblock, polylactic acid, styrene block copolymers, polystyrene, general purpose polystyrene (GPPS) impact modified with impact modifiers such as SEBS, SBS, SIS, or other suitable modifiers, and blends of any of the foregoing. In some embodiments, each skin layer may be about 3% to about 40% of the total relative thickness of a film. In other embodiments, each skin layer of a film may have a thickness that is about 4 to about 35% of the total relative thickness of the film. In still other embodiments, a skin layer may constitute about 5% to about 30% of the total relative thickness of a film. Furthermore, as indicated above, some films of the present invention may have multiple skin layers, in which case each skin layer may have a thickness in the aforementioned ranges and also the total thickness of all skin layers may be within the aforementioned ranges.

In some embodiments, films of the present invention may include skins comprised of a blend of cyclic polyolefin and low density polyethylene. In other embodiments, skins of the present invention may be comprised of cyclic polyolefin and linear low density polyethylene. For example, in one particular embodiment, the cyclic polyolefin may have a density of about 1.02 g/cc and the low density polyethylene may have a density in the range of about 0.868 to about 0.93 g/cc, with each range including each intermittent value therein. The percentage by weight of cyclic polyolefin to low density polyethylene may vary in differing embodiments of the invention. In some embodiments, for example, cyclic polyolefin may constitute by weight from about 40% to about 95% of a skin layer. In other embodiments, cyclic polyolefin may constitute by weight from about 45% to about 93%, or alternatively from about 50% to about 90%, of a skin layer. In addition, a skin layer may also include about 5% to about 60% low density polyethylene and/or linear low density polyethylene. In some embodiments, the weight ratio of cyclic polyolefin to low density polyethylene and/or linear low density polyethylene may be in the range of about 40:60 to about 95:5, specifically including each intermittent value therein. In some embodiments, the percentage by weight may be about 50:50, 70:30, 74:26, 85:15, or 90:10. In still other embodiments, skin layers of the present invention may also comprise one or more polyolefin elastomers.

In some embodiments, skin layers of a film may also include other components. For example, skin layers in some embodiments may be prepared using PETG, in which case the skin layers may constitute up to a total of about 15% of the total relative thickness of the film. In such embodiments, the skin layer may contain 100% PETG by weight or, in other embodiments, blends of PETG with PET and optionally with up to about 5% antiblock (as measured based on the active ingredients). In some embodiments, a skin layer may be prepared using general purpose polystyrene (GPPS) impact modified with impact modifiers such as SEBS, SBS, SIS, or other suitable modifiers at an amount of about 20% by weight, in which case the skin layers may constitute up to a total of about 50% of the total relative thickness of the film or, about 25% of the total relative thickness of the film per skin layer in embodiments having two skin layers.

In some embodiments, films of the present invention may include one or more tie layers. When present, a tie layer may be located between two layers of the film and may function to improve adherence between the two layers of the film. In some embodiments, a tie layer may be present between a core layer and a skin layer. Any suitable material, based upon the desired properties and the core layer and skin layer materials, may be used for the tie layer.

By way of example and without limitation, tie layers may include olefin block copolymers, maleic anhydride; maleic anhydride grafted ethylene acrylate; modified polymers, such as styrene maleic anhydride; polyolefin modified with maleic anhydride; and block copolymers, such as styrene ethylene butylene styrene (SEBS) copolymer and styrene isoprene styrene (SIS) copolymer. In other embodiments, depending on the compositions of the two layers of the film which the tie layer is located between, the tie layer can include at least one thermoplastic polymer selected from the group consisting of a polyolefin to include, for example, ethylene and propylene homopolymers and copolymers and block copolymers, an unsaturated carboxylic acid or anhydride grafted polyolefin to include for example maleic anhydride grafted polypropylenes and maleic anhydride grafted polyethylenes, an alkene-unsaturated carboxylic acid or unsaturated carboxylate ester copolymer to include for example ethylene-alkyl methacrylate copolymers and ethylene-vinyl acetate copolymers, a metal salt of an alkene-unsaturated carboxylic acid copolymer to include for example ionomers which are sodium or zinc salts of ethylene-methacrylic acid copolymers, a styrene homopolymer or copolymer, a cyclic olefin homopolymer or copolymer, a halogen-containing polymer, a polyurethane, a polycarbonate, a polyacrylonitrile, a polyamide, an aromatic polyether, an aromatic polyimide, an aromatic polyamide-imide, a (meth)acrylate polymer, a polyester to include for example poly(ethylene terephthalate)s, a hydrocarbon resin to include for example hydrogenated polyterpene resins, and a mixture of two or more of any of the foregoing polymers.

As set forth above, the present invention can include various formulations. Without limiting the present invention, the following formulations provide illustrative formulations of multilayer films of the present invention (wherein the percentages indicate the weight percentage of the entire respective layer with respect to the entire film):

PETG/Tie/75 Engage 25LLDPE/Tie/PETG

| | | | | |
|---|---|---|---|---|
| 9% | 5% | 72% | 5% | 9% |

PETG/Tie/Engage/Tie/PETG

| | | | | |
|---|---|---|---|---|
| 9% | 5% | 72% | 5% | 9% |

PETG/Tie/VERSIFY/Tie/PETG

| | | | | |
|---|---|---|---|---|
| 9% | 5% | 72% | 5% | 9% |

80 SBC & 20 GPPS/VERSIFY/80 SBC & 20 GPS

| | | |
|---|---|---|
| 25% | 50% | 25% |

70 COC & 30 Engage/Versify/70 COC & 30 Engage

| | | |
|---|---|---|
| 12% | 76% | 12% |

70 COC & 30 Engage/Versify/70 COC & 30 Engage

| | | |
|---|---|---|
| 25% | 50% | 25% |

70 COC & 30 Engage/Versify/70 COC & 30 Engage

| | | |
|---|---|---|
| 22.5% | 55% | 22.5% |

50 COC & 50 LDPE/MDPE/50 COC & 50 LDPE

| | | |
|---|---|---|
| 25% | 50% | 25% |

50 COC & 50 LDPE/MDPE/50 COC & 50 LDPE

| | | |
|---|---|---|
| 20.0% | 60% | 20.0% |

PETG/Tie/Versify/Tie/PETG

| | | | | |
|---|---|---|---|---|
| 18% | 5% | 54% | 5% | 18% |

PETG/Tie/EVA/Tie/PETG

| | | | | |
|---|---|---|---|---|
| 25 | 7.5 | 35 | 7.5 | 25 |

PETG/Tie/EVA/Tie/PETG

| | | | | |
|---|---|---|---|---|
| 25 | 7.5 | 35 | 7.5 | 25 |

As indicated in the particular table above, PETG is glycol modified polyethylene terephthalate from SK Chemical Co., Ltd., GPPS indicates general purpose polystyrene, SBC indicates styrene block copolymer, EVA indicates ethylene vinyl acetate, LLDPE indicates linear low density polyethylene, LDPE indicates low density polyethylene, MDPE indicates medium density polyethylene, Engage indicates olefinic elastomer products available from The Dow Chemical Company, including, Engage 8150G, and Versify indicates the product Versify 2300 from The Dow Chemical Company. In addition, Tie in the table above references Bynel 21E787, which is an anhydride modified ethylene acrylate resin that is available from DuPont Company.

The overall density of films of the present invention may be less than about 1.0 g/cc in some embodiments. In other embodiments, films of the present invention may have a density of less than about 0.98 g/cc. In still other embodiments, films of the present invention may have a density of less than about 0.96 g/cc.

In some embodiments of the present invention, a multilayer shrink film may have a machine direction shrink percentage of about 5% to about 75%. In addition, in some embodiments, multilayer shrink films of the present invention may have a cross direction growth percentage of about 0% to about 20%. Films of the present invention may also have a cross directional growth upon shrinkage in the machine direction. In addition, films of the present invention may demonstrate a shrink tension in the range of about 200 psi to about 950 psi.

In some embodiments of the present invention, the density of the core layer controls, in whole or in part, the degree of shrinking of the film. In this regard, the density of a core layer may be decreased in order to obtain an increase in the shrink percentage in the machine direction. In similar fashion, the density of the core layer may also be used to control growth of a film in the cross direction. As explained in more detail below, films may be designed in accordance with methods of the present invention in order to achieve desired shrink properties in a film.

In addition to shrink percentage values, films of the present invention may have, in some embodiments, certain optical properties. For example, in some embodiments, films of the present invention may have clarity of greater than 80%. In other embodiments, films of the present invention may have clarity of greater than 85% or, in still other embodiments, greater than 90%. In addition, films of the present invention may have haze that is less than 20% in some embodiments. In some embodiments, films of the present invention may have haze of less than 10% or, in other embodiments, less than 8%. In addition, in some embodiments, films of the present invention may have gloss, measured at 60°, that is greater than 80 gloss units (GU). In other embodiments, films of the present invention may have gloss of greater than 85 GU or, in other embodiments, greater than 90 GU.

For example, in some illustrative embodiments, films of the present invention may have a gloss in the machine direction in the range of about 79 to about 130 GU, a gloss in the cross direction in the range of about 50 to about 110 GU, a haze in the range of about 2% to about 15%, and a clarity in the range of about 80% to about 99%. In addition, films of the present invention may have machine direction modulus in the range of about 80 to about 220 kilopounds per square inch (ksi) and a cross direction modulus in the range of about 50 to about 250 ksi. In addition, films of the present invention may have a shrink tension in the range of about 200 to about 1,000 psi or, in some embodiments, in the range of about 250 to about 900 psi.

One of ordinary skill in the art will appreciate that films of the present invention may be prepared using any suitable techniques. For example, in some embodiments, multilayer films of the present invention may be prepared using cast film processes, blown film processes, and extrusion and coextrusion processes. In addition, in some embodiments, films of the present invention may be oriented in the machine direction only.

For reference, Table I below provides exemplary embodiments of films of the present invention and parameters used in their manufacture. As shown in Table I, Samples A-M were prepared using a coextrusion cast film process and the films were oriented in the machine direction only. The skin layers of the sample films were present on each side of the core layer, and each skin layer constituted 25% of the total film thickness. The core of the sample film constituted 50% of the total film thickness. Samples A-M did not include a tie layer and Sample N-T included a tie layer prepared using maleic anhydride grafted ethylene acrylate.

TABLE I
Samples A-T

| | | | | | | | | | | | Percent |
|---|---|---|---|---|---|---|---|---|---|---|---|
| | | skin | skin | core | | | | MDO | MDO | | of |
| | | polymer 1/ | polymer 2/ | polymer/ | overall | MDO | MDO | slow | fast | Annealing | Anneal |
| | skin | density 1 | density 2 | density | density | Temp | ratio | rate | rate | Temp. | each |
| Sample | blend ratio | (g/cc) | (g/cc) | (g/cc) | (g/cc) | (F.) | (X) | (ft/min) | (ft/min) | (F.) | roll |
| A | A-1 | COC/d = 1.02 | LDPE/ | LLDPE/ | 0.956 | 190 | 3.31 | 8 | 26.48 | 140 | 2 |
| | (COC/LDPE′:50/50) | | d = 0.93 | d = 0.937 | | | | | | | |
| B | A-1′ | COC/d = 1.02 | LDPE/ | LLDPE/ | 0.956 | 190 | 3.31 | 8 | 26.48 | 140 | 2 |
| | (COC/LDPE′:50/50) | | d = 0.93 | d = 0.937 | | | | | | | |
| C | A-2 | COC/d = 1.02 | LDPE/ | LLDPE/ | 0.965 | 190 | 3.31 | 8 | 26.48 | 140 | 2 |
| | (COC/LDPE′:70/30) | | d = 0.93 | d = 0.937 | | | | | | | |
| D | A-2′ | COC/d = 1.02 | LDPE/ | LLDPE/ | 0.965 | 190 | 3.31 | 8 | 26.48 | 140 | 2 |
| | (COC/LDPE′:74/26) | | d = 0.93 | d = 0.937 | | | | | | | |
| E | A-3 | COC/d = 1.02 | LDPE/ | LLDPE/ | 0.9695 | 190 | 3.31 | 8 | 26.48 | 140 | 2 |
| | (COC/LDPE′:90/10) | | d = 0.93 | d = 0.937 | | | | | | | |
| F | C-1 | COC/d = 1.02 | LDPE/ | LLDPE/ | 0.944 | 190 | 3.31 | 8 | 26.48 | 140 | 2 |
| | (COC/LDPE″:50/50) | | d = 0.92 | d = 0.918 | | | | | | | |
| G | C-2 | COC/d = 1.02 | LDPE/ | LLDPE/ | 0.956 | 190 | 2.68 | 8 | 21.44 | 140 | 2 |
| | (COC/LDPE″:74/26) | | d = 0.92 | d = 0.918 | | | | | | | |
| H | C-2 | COC/d = 1.02 | LDPE/ | LLDPE/ | 0.956 | 190 | 3.31 | 8 | 26.48 | 140 | 2 |
| | (COC/LDPE″:74/26) | | d = 0.92 | d = 0.918 | | | | | | | |
| I | C-3 | COC/d = 1.02 | LDPE/ | LLDPE/ | 0.959 | 190 | 3.31 | 8 | 26.48 | 140 | 2 |
| | (COC/LDPE″:90/10) | | d = 0.92 | d = 0.918 | | | | | | | |
| J | D-1 | COC/d = 1.02 | LDPE/ | Engage/ | 0.919 | 190 | 3.31 | 8 | 26.48 | 140 | 2 |
| | (COC/LDPE″:50/50) | | d = 0.92 | d = 0.868 | | | | | | | |
| K | D-2 | COC/d = 1.02 | LDPE/ | Engage/ | 0.931 | 190 | 3.31 | 8 | 26.48 | 140 | 2 |
| | (COC/LDPE″:74/26) | | d = 0.92 | d = 0.868 | | | | | | | |
| L | D-2′ | COC/d = 1.02 | LDPE/ | Engage/ | 0.931 | 190 | 3.31 | 8 | 26.48 | 140 | 2 |
| | (COC/LDPE″:74/26) | | d = 0.92 | d = 0.868 | | | | | | | |
| M | D-3 | COC/d = 1.02 | LDPE/ | Engage/ | 0.934 | 190 | 3.31 | 8 | 26.48 | 140 | 2 |
| | (COC/LDPE″:90/10) | | d = 0.92 | d = 0.868 | | | | | | | |
| N | A-1 | COC/d = 1.02 | LDPE/ | 50% | 0.913 | 180 | 2.7 | 8 | 21.60 | 140 | 2 |
| | (COC/LDPE:85/15) | | d = 0.92 | Versify + | | | | | | | |
| | | | | 50% RCP/ | | | | | | | |
| | | | | d = 0.883 | | | | | | | |
| O | A-1 | COC/d = 1.02 | LDPE/ | 70% | 0.908 | 180 | 2.7 | 8 | 21.60 | 140 | 2 |
| | (COC/LDPE:85/15) | | d = 0.92 | Versify + | | | | | | | |
| | | | | 30% RCP/ | | | | | | | |
| | | | | d = 0.877 | | | | | | | |
| P | A-1 | COC/d = 1.02 | LDPE/ | 80% | 0.906 | 180 | 2.7 | 8 | 21.60 | 140 | 2 |
| | (COC/LDPE:85/15) | | d = 0.92 | Versify + | | | | | | | |
| | | | | 20% RCP/ | | | | | | | |
| | | | | d = 0.873 | | | | | | | |
| Q | A-1 | COC/d = 1.02 | LDPE/ | 90% | 0.903 | 180 | 2.7 | 8 | 21.60 | 140 | 2 |
| | (COC/LDPE:85/15) | | d = 0.92 | Versify + | | | | | | | |
| | | | | 10% RCP/ | | | | | | | |
| | | | | d = 0.870 | | | | | | | |
| R | A-1 | COC/d = 1.02 | LDPE/ | 100% | 0.901 | 180 | 2.7 | 8 | 21.60 | 140 | 2 |
| | (COC/LDPE:85/15) | | d = 0.92 | Versify/ | | | | | | | |
| | | | | d = 0.867 | | | | | | | |
| S | PETG 100% | — | *Tie layer = | 75% | 0.949 | 180 | 3.0 | 9.3 | 27.90 | 160 | 2 |
| | | | Maleic | Versify + | | | | | | | |
| | | | Anhydride | 25% RCP/ | | | | | | | |
| | | | Grafted | d = 0.875 | | | | | | | |
| | | | Ethylene | | | | | | | | |
| | | | Acrylate | | | | | | | | |
| | | | 100% | | | | | | | | |
| T | PETG 100% | — | *Tie layer = | 100% | 0.946 | 180 | 3.0 | 9.3 | 27.90 | 160 | 2 |
| | | | Maleic | Versify/ | | | | | | | |
| | | | Anhydride | d = 0.867 | | | | | | | |
| | | | Grafted | | | | | | | | |
| | | | Ethylene | | | | | | | | |
| | | | Acrylate | | | | | | | | |
| | | | 100% | | | | | | | | |

*As used in Table I, RCP indicates a random copolymer that is polypropylene-based with an ethylene comonomer and Engage indicates Engage 8842, available from The Dow Chemical Company.

After preparation of Samples A-M, each sample was tested for shrinkage and optical properties. The testing was conducted in the following manners using the referenced ASTM standard for testing with any noted modifications:

As shown in Table I, Samples A-M included some samples having the same formulation but differing core densities.

| Test | Description | Standard |
|---|---|---|
| Hot oil shrink | To determine the amount of shrinkage | ASTM 2732 |
| test | of a plastic film by exposing the film to | |
| | an elevated temperature in oil | |
| Optics (gloss) | To measure the specular gloss of | ASTM D2457 |
| | plastic films at 60°, 20°, and/or 85° | |
| Optics (haze | To evaluate transmittance, haze and | ASTM D2457 |
| and clarity) | clarity by measuring the resultant light | |
| | passed through the plastic film from a | |
| | light source | |
| Oven shrink | To determine the amount of shrinkage | ASTM 1204* |
| | of a plastic film by exposing the film to | *modified testing condition |
| | an elevated temperature in air | as 5 minutes at 100° C. |
| | | (the ASTM standard is 15 |
| | | minutes at 100° C.) |
| Physical | To determine modulus and three | ASTM D882 |
| properties | tensile breaking properties: the force | |
| (modulus, | per unit width required to break a | |
| tensile | specimen (tensile strength), the | |
| strength, and | percentage elongation at break | |
| elongation) | (stretch), and the energy absorbed per | |
| | unit area of the specimen before | |
| | breaking (tensile energy absorption, | |
| | TEA) | |
| Shrink tension | To measure the maximum force | ASTM 2838 |
| | exerted by a plastic film that is totally | |
| | restrained from shrinking as it is | |
| | heated rapidly to a specific | |
| | temperature | |
| Density | Calculated based on weight average of | N/A |
| | each component density as reported | |
| | by literature. | |

The results of this testing is reported in Tables II and III below:

TABLE II
Sample A-M Shrink Testing Results

| | Oven at 100° C. at 5 minutes | | | | Oil at at 100° C. at 10 seconds | | | |
|---|---|---|---|---|---|---|---|---|
| | MD | | CD | | MD | | CD | |
| | shrink | | growth | | shrink | | growth | |
| Sample | (%) | stdev | (%) | stdev | (%) | stdev | (%) | stdev |
| A | 26.1% | 0.2% | −0.7% | 0.3% | 30.4% | 3.1% | −1.3% | 0.50% |
| B | 23.2% | 0.2% | −2.0% | 0.4% | 27.2% | 0.1% | −1.3% | 0.40% |
| C | 26.3% | 1.0% | −1.3% | 0.2% | 30.7% | 0.5% | −1.1% | 0.30% |
| D | 21.4% | 0.4% | −1.4% | 0.2% | 25.4% | 0.7% | −1.6% | 0.10% |
| E | 29.4% | 0.3% | −2.6% | 0.1% | 33.4% | 1.3% | −2.6% | 0.30% |
| F | 51.20% | 0.90% | −2.50% | 0.2% | 55.10% | 1.00% | −2.70% | 0.10% |
| G | 51.1% | — | −4.5% | — | — | — | — | — |
| H | 45.5% | 0.3% | −3.7% | 0.2% | 45.3% | 0.5% | −3.4% | 0.38 |
| I | 50.6% | 1.5% | −4.4% | 0.1% | 51.7% | 1.6% | −4.3% | 0.4 |
| J | 52.90% | 0.90% | −4.60% | 0.2% | 52.30% | 1.33% | −5.8% | 0.5% |
| K | 63.4% | 0.4% | −6.1% | 0.2% | 62.8% | 0.7% | −8.2% | 1.0% |
| L | 57.4% | 0.2% | −5.6% | 0.2% | 62.7% | 1.4% | −8.9% | 1.5% |
| M | 66.7% | 0.1% | −3.3% | 0.1% | 67.1% | 0.5% | −4.5% | 0.7% |
| N | 52.1% | 0.2% | −2.2% | 0.0% | N/A | N/A | N/A | N/A |
| O | 57.2% | 0.2% | −2.9% | 1.4% | N/A | N/A | N/A | N/A |
| P | 59.5% | 0.6% | −3.3% | 0.2% | N/A | N/A | N/A | N/A |
| Q | 62.1% | 0.4% | −4.0% | 0.3% | N/A | N/A | N/A | N/A |
| R | 64.4% | 0.4% | −4.5% | 0.5% | N/A | N/A | N/A | N/A |
| S | 60.7% | 0.3% | −10.0% | 0.1% | N/A | N/A | N/A | N/A |
| T | 69.4% | 0.1% | −15.6% | 0.5% | N/A | N/A | N/A | N/A |

TABLE III
Sample A-M Optical Properties

| | | | | | MD | CD | shrink |
|---|---|---|---|---|---|---|---|
| | gloss | gloss | | | modulus | modulus | tension |
| Sample | MD | CD | haze | clarity | (ksi) | (ksi) | (ksi) |
| A | 109.9 | 69.9 | 5.85 | 86.6 | 162.9 | 149.1 | 832.8 |
| B | 88.7 | 50.2 | 11.9 | 77.9 | 134.2 | 109.3 | 802.3 |
| C | 106.8 | 89.4 | 5.41 | 95 | 193.2 | 160.3 | 896.6 |
| D | 71.9 | 52 | 20.5 | 90.3 | 156 | 104.4 | 658.6 |
| E | 66.1 | 42.1 | 30.8 | 85.1 | 171.4 | 129.3 | 915.37 |
| F | 92.7 | 54.3 | 10.4 | 78.4 | 123.2 | 85.7 | 716.6 |
| G | 107 | 74 | 7.8 | 84.3 | 138.2 | — | — |
| H | 79.2 | 58.8 | 14.8 | 93.3 | 145.7 | 116.7 | 764.1 |
| I | 72.4 | 56.9 | 20.4 | 91.1 | 137.8 | 116.3 | 830.33 |
| J | 98.8 | 56.6 | 8.6 | 80.2 | 83.8 | 55.4 | 333.1 |
| K | 80.6 | 66.8 | 7.2 | 95.9 | 127.4 | 79.1 | 356.9 |
| L | 82.2 | 62.3 | 12.7 | 93.6 | 98.8 | 65.4 | 408.1 |
| M | 78.2 | 60.6 | 19.6 | 93.1 | 130.6 | 83.4 | 476.5 |
| N | 99.3 | 85.0 | 4.9 | 96.5 | N/A | N/A | N/A |
| O | 100.3 | 96.3 | 6.0 | 97.9 | N/A | N/A | N/A |
| P | 102.7 | 91.0 | 4.7 | 98.1 | N/A | N/A | N/A |
| Q | 100.0 | 94.0 | 5.0 | 98.1 | N/A | N/A | N/A |
| R | 94.3 | 82.7 | 6.5 | 94.2 | N/A | N/A | N/A |
| S | 123.0 | 125.2 | 1.88 | 98.1 | N/A | N/A | N/A |
| T | 119.0 | 127.0 | 1.72 | 98.2 | N/A | N/A | N/A |

In some embodiments, the present invention also includes skin layers prepared using polystyrene. Such skin layers may be used in with a polyolefin core, in the manner described above. For example, and without limitation, the following Sample U and Sample V provide illustrative embodiments of skin layers and tie layers that may be used within the scope of the current invention.

| | | Sample U | Sample V |
|---|---|---|---|
| | Layer | 5 Layers [A-B-C-B-A] | 5 Layers [A-B-C-B-A] |
| | Structure: | | |
| Skin | Layer | 20-35% | 20-35% |
| Layer (A) | Percentage: | | |
| | Resin | American Styrenics | American Styrenics |
| | Composition | Polystyrene | Polystyrene |
| | | EA3400:Kraton | EA3400:Kraton |
| | | G2832 (93:7) | G2832 (93:7) |
| | COC | NA | NA |
| | Blend Ratio | | |
| Tie | Layer | 10-20% | 10-20% |
| Layer (B) | Percentage: | | |
| | Resin | Septon 2004 | Dowlex LDPE |
| | Composition | | 722:Amplify 3351 |
| | | | (10:90) |
| | Blend Ratio | NA | NA |
| Skin | Layer | 55-70% | 55-70% |
| Layer (C) | Percentage: | | |
| | Resin | Huntsman LDPE | Huntsman LDPE |
| | Composition | PE1017:Dowlex LDPE | PE1017:Dowlex LDPE |
| | | 722:Engage 8842 | 722:Engage 8842 |
| | | (40:50:10) | (40:50:10) |

As referenced in Table V, Polystyrene EA3400 indicates a polystyrene product available from American Styrenics, LLC, G2832 indicates a Kraton G2832 is a styrene-ethylene/butylenes-styrene (SEBS) block copolymer available from Kraton Polymers, LDPE indicates low density polyethylene, specifically Dowlex LDPE 722 available from The Dow Chemical Company, Septon 2004 indicates a styrene ethylene propylene styrene block copolymer available under the brand name Septon 2004 from Kuraray CO., Ltd., Amplify 3351 indicates a maleic anhydride grafted polymer available under the brand name Amplify 3351 from The Dow Chemical Company, Huntsman LDPE PE1017 indicates low density polyethylene under the brand name PE1017 available from Huntsman Corporation, Dowlex LDPE 722 indicates a low density polyethylene available under the brand name Dowlex LDPE 722 from The Dow Chemical Company, and Engage 8842 indicates a polyolefin elastomer available from the Dow Chemical Company. One of ordinary skill in the art readily appreciates that the foregoing specific references to compounds is exemplary in nature only and that other compositions are within the scope of the present invention.

Sample U and Sample V were also tested for certain parameters. Although layer percentage ranges are provided for these samples above, the actual tested samples had a skin layer percentage of 25% total (12.5% on each side), a tie layer percentage of 14% total (7% on each side), and a core layer percentage of 61% total. Based upon that testing, the following results were obtained:

| | |
|---|---|
| Sample U | Sample V |

MD Oven Shrinkage Percentage @ 5 min

| | | |
|---|---|---|
| 70° C. | 1 | 1 |
| 80° C. | 3 | 3 |
| 90° C. | 10 | 9 |
| 100° C. | 42 | 36 |
| 110° C. | 68 | 55 |
| 125° C. | 74 | 75 |

DMA Shrink curve @ 3 C./min

| | | |
|---|---|---|
| Shrink Onset temperature | — | 84° C. |
| Temp @ 2% Shrink | | |
| Temp @ 5% Shrink | — | 92° C. |
| Temp @ 35% Shrink | — | 109° C. |

Optical properties

| | | |
|---|---|---|
| Transmittance | 90.5 | 90.2 |
| Haze | 2.5 | 3.9 |
| Clarity | 99 | 95 |
| MD Gloss @ 60 Degree | 130 | 115 |
| CD Gloss @ 60 Degree | 124 | 113 |

In other embodiments, the present invention also includes methods for selecting compositions and/or core layer densities for a film in order for the film to have a desired machine direction shrink percentage and/or cross direction growth percentage. Based upon these selections, films may be manufactured using the selected materials and core density in order to obtain a film with the desired shrink properties. These methods may be illustrated, by way of example, with reference to the data in Tables I, II, and III.

For example, as indicated by the testing data in Table IV below, which is data excerpted from Table I, a general trend may be observed that the machine direction shrink percentage of a film increases as the core density of the film is decreased. In addition, with some exception in the experimental results, a second trend may be observed that greater amounts of COC in the skin layer may result in increased MD shrinkage.

TABLE IV
Machine Direction Shrink Percentages

| Skin Ratio | | | |
|---|---|---|---|
| COC (d = | core | | |
| 1.02):LDPE | LLDPE/ | LLDPE/ | Engage/ |
| (d = 0.93)* | d = 0.937 | d = 0.918 | D = 0.868 |
| 50:50 | 26.1% | 51.2% | 52.9% |
| 74:26 | 21.4% | 45.5% | 63.4% |
| 90:10 | 29.4% | 51.7% | 67.1% |

The foregoing trend may also be illustrated, by way of example, with reference to Samples N—R. In particular, as shown in Table V below, as the core layer density is decreased by varying the core layer composition, the shrink percentage increases.

| | | | Core | MD | CD |
|---|---|---|---|---|---|
| Sample | Skin | Core | Density | Shrink | Shrink |
| R | COC 85%/ | 100% Versify | 0.867 | 64.4% | −4.5% |
| | LDPE 15% | | | | |
| Q | COC 85%/ | 90% Versify + | 0.870 | 62.1% | −4.0% |
| | LDPE 15% | 10% RCP | | | |
| P | COC 85%/ | 80% Versify + | 0.873 | 59.5% | −3.3% |
| | LDPE 15% | 20% RCP | | | |
| O | COC 85%/ | 70% Versify + | 0.877 | 57.2% | −2.9% |
| | LDPE 15% | 30% RCP | | | |
| N | COC 85%/ | 50% Versify + | 0.883 | 52.1% | −2.2% |
| | LDPE 15% | 50% RCP | | | |

Using methods of the present invention, data such as that in Table IV and Table V, for example, may be used and extrapolated to select film compositions and/or core layer densities to manufacture a multilayer film having predetermined shrinkage properties. For example, by analyzing and extrapolating from the data in Table IV, which may be considered reference data, a film composition and/or a core layer density may be selected for a film to achieve a predetermined machine direction shrink percentage. In some embodiments, for instance, regression analysis or curve fitting may be applied to reference data in order to obtain approximate machine direction shrink percentages for films having other core layer densities that have not been actually tested or included in the reference data. As result, if a film is desired having a particular machine direction shrink percentage, the methods of the present invention may be used to select the core density of the film that will provide the desired shrink percentage based upon such extrapolations. Reference to Table IV herein is for illustration and is not intended to limit the full scope of the invention.

In addition, as shown by the foregoing data, particular formulations for film layers and/or materials for film layers may also be selected by extrapolating reference data in the same manner based upon a desired shrink percentage. For example, different core layer and skin layer formulations may yield varying shrinkage results at a given core layer density. Therefore, in the same manner as described above for core layer densities, reference data may be extrapolated to select materials and formulations for the core layer and skin layer of a film to obtain a desired shrinkage property.

In some embodiments, at least three data points for a variable may be analyzed for selecting a parameter. For example, if a core density is being selected to obtain a desired shrink percentage, shrinkage data for at least three film samples having the same or substantially the same composition may be obtained, wherein each film sample has a different density. The shrinkage data for those at least three samples may then be extrapolated in order to estimate the core layer density for a film having the desired shrinkage property. In other embodiments, extrapolations may be made from shrinkage data for four or more such film samples having substantially the same compositions and differing densities.

In other embodiments, shrinkage data may be obtained for at least two or more series of film samples. In this regard, a series of film samples includes a plurality of film samples having the same or substantially the same composition but different core layer densities. The composition of a film may differ between different film series. By compiling shrinkage data for at least two film series, a film may be prepared having a desired shrink percentage by extrapolating data for two series such that shrinkage parameters may be considered for different film compositions and core layer densities in order to select suitable parameters to obtain a desired film shrinkage.

In some embodiments, other parameters may be considered in selected the composition of a film or the density of its core layer. For example, desired optical factors may also be considered in the analysis based upon reference data.

In some embodiments, the reference data for film samples used in methods of the present invention may be obtained through actual testing. In other embodiments, the reference data for film samples may be obtained from any suitable sources, including publications and reference materials. In still other embodiments, such reference data may be obtained from actual testing and from other sources.

In other embodiments of the present invention, selection guides may be prepared for selecting compositions and/or core densities that may be used in a multilayer film to obtain a desired shrinkage. In some embodiments, such a guide may be in the form of a computer program that can be executed in a computer system. For example, a user may enter the desired shrinkage parameters in a film product and, pursuant to the methods described above, the computer program may generate one or more options of film compositions and core layer densities that may be used to obtain the desired shrinkage in a film.

These and other modifications and variations to the present invention may be practiced by those of ordinary skill in the art without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A multilayer shrink film comprising:
a core layer comprised of polymeric material,
a skin layer comprised of shrinkable polymeric material, wherein the skin layer overlies the core layer,
wherein the core layer has a density in the range of about 0.857 to about 0.94,
wherein the overall density of the film is less than about 1.0 g/cc,
wherein the film is configured to shrink in the machine direction.

2. The multilayer shrink film of claim 1 wherein the film is configured to grow in the cross direction upon exposure to a shrink temperature.

3. The multilayer shrink film of claim 1 wherein the polymeric material of the core layer comprises one or more olefin polymers.

4. The multilayer shrink film of claim 3 wherein the olefin polymers are selected from the group consisting of low density polyethylene, linear low density polyethylene, medium density polyethylene, polypropylene, or combinations thereof.

5. The multilayer shrink film of claim 1 wherein the polymeric material of the core layer comprises ethyl vinyl acetate.

6. The multilayer shrink film of claim 1 wherein the polymeric material of the core layer comprises a polymeric material selected from the group consisting of olefin polymers and comonomers.

7. The multilayer shrink film of claim 1 wherein the density of the core layer is substantially attributable to the polymeric material, wherein the polymeric material comprises olefin elastomers, other olefin polymers, or a combination thereof.

8. The multilayer shrink film of claim 1 wherein the polymeric material of the core layer is selected from the group consisting of low density polyethylene, linear low density polyethylene, medium density polyethylene, ethyl vinyl acetate, polypropylene elastomer, and combinations thereof.

9. The multilayer shrink film of claim 1 wherein the core layer comprises one or more of elastomers and plastomers.

10. The multilayer shrink film of claim 1 wherein the shrinkable polymeric material of the skin layer comprises one or more of cyclic polyolefin (COC), polyolefin, polyester, modified polyester (PETG), polylactic acid, styrene block copolymers, polystyrene, general purpose polystyrene (GPPS) impact modified with impact modifiers such as SEBS, SBS, SIS, or other suitable modifiers, and blends thereof.

11. The multilayer shrink film of claim 1 wherein the shrinkable polymeric material of the skin layer comprises cyclic polyolefin and one or more of low density polyethylene and linear low density polyethylene.

12. The multilayer shrink film of claim 11 wherein the shrinkable polymeric material of the skin layer comprises cyclic polyolefin and one or more of low density polyethylene and linear low density polyethylene in a weight ratio in the range of about 50:50 to about 90:10.

13. The multilayer shrink film of claim 1 wherein the shrinkable polymeric material of the skin layer comprises about 50% to about 99% cyclic polyolefin by weight.

14. The multilayer shrink film of claim 1 wherein the shrinkable polymeric material of the skin layer comprises about 74% cyclic polyolefin and about 26% low density polyethylene by weight.

15. The multilayer shrink film of claim 1 wherein the shrinkable polymeric material of the skin layer comprises about 85% cyclic polyolefin by weight and a total of about 15% low density polyethylene, linear low density polyethylene, or combinations thereof by weight.

16. The multilayer shrink film of claim 1 wherein the skin layer comprises polyethylene terephthalate glycol-modified.

17. The multilayer shrink film of claim 1 wherein the skin layer comprises modified polyester and polyethylene terephthalate glycol-modified, wherein the polyethylene terephthalate glycol-modified comprises less than about 10% by weight of the skin layer.

18. The multilayer shrink film of claim 1 further comprising a tie layer, wherein the tie layer is between at least one core layer and at least one skin layer.

19. The multilayer shrink film of claim 18 wherein the tie layer comprises one or more of olefin block copolymers, maleic anhydride, modified polymers, block copolymers, styrene maleic anhydride, polyolefin modified with maleic anhydride, and styrene ethylene butylene styrene (SEBS) copolymer.

20. The multilayer shrink film of claim 19, wherein the tie layer comprises less than about 10% by weight of styrenic compounds.

21. The multilayer shrink film of claim 1 wherein the machine direction shrink percentage of the film is controlled by the density of the core layer of the film.

22. The multilayer shrink film of claim 1 wherein the core layer comprises one polymeric material.

23. The film of claim 1 wherein the shrinkable polymeric material of the skin layer comprises PETG and wherein the skin layer constitutes up to about 15% of the total relative thickness of the film.

24. The film of claim 1 wherein the shrinkable polymeric material of the skin layer comprises PETG and wherein all skin layers constitute up to about 15% % of the total relative thickness of the film.

25. The film of claim 24 wherein the shrinkable polymeric material of the skin layer further comprises PET.

26. The film of claim 1 wherein the shrinkable polymeric material of the skin layer comprises general purpose polystyrene (GPPS) impact modified with impact modifiers such as SEBS, SBS, SIS, or other suitable modifiers at an amount of about 20% by weight and wherein all skin layers constitute up to about 50% of the total relative thickness of the film.
